(19) United States
(12) Patent Application Publication
(10) Pub. No.: US 2025/0220542 A1
(43) Pub. Date: Jul. 3, 2025

(54) INFORMATION PROCESSING DEVICE

(71) Applicant: TOYOTA JIDOSHA KABUSHIKI KAISHA, Toyota-shi (JP)

(72) Inventors: Hiroshi ABE, Kasukabe-shi (JP); Koji Takeoka, Yokohama-shi (JP); Kiichi Iwasaki, Nagoya-shi (JP); Takayuki Sakai, Tokyo (JP); Isao Nishioka, Nagoya-shi (JP); Yasuhiro Kobatake, Nagoya-shi (JP); Noriaki Ito, Okazaki-shi (JP)

(73) Assignee: TOYOTA JIDOSHA KABUSHIKI KAISHA, Toyota-shi (JP)

(21) Appl. No.: 18/904,091

(22) Filed: Oct. 2, 2024

(30) Foreign Application Priority Data
Dec. 28, 2023 (JP) 2023-222314

(51) Int. Cl. H04W 36/30; H04W 4/40; H04W 4/90; H04W 24/04; H04W 76/19

(52) U.S. Cl. CPC H04W 36/305; H04W 4/40; H04W 4/90; H04W 24/04; H04W 76/19

(57) ABSTRACT

An information processing device comprising: a communication module connectable to both a first cellular communication network and a second cellular communication network; and a control unit. when a failure occurs in the first cellular communication network, the control unit switches a communication network to be used to the second cellular communication network for a vehicle mounted application classified into a prescribed category from among a plurality of vehicle mounted applications that use the first cellular communication network.

### CROSS-REFERENCE TO RELATED APPLICATION

This application claims priority to Japanese Patent Application No. 2023-222314 filed on Dec. 28, 2023, incorporated herein by reference in its entirety.

### BACKGROUND

### 1. Technical Field

The present disclosure relates to communication technology.

### 2. Description of Related Art

There is technology that dynamically selects a communication system to be used by a moving body. In relation to this point, for example, Japanese Unexamined Patent Application Publication No. 2007-214756 (JP 2007-214756 A) discloses a terminal device that performs communication by selecting a communication unit with a highest reliability from among a plurality of communication units when an emergency situation occurs.

### SUMMARY

The present disclosure has an objective of establishing both securing of availability and suppression of cost in communication.

One aspect of an embodiment of the present disclosure is an information processing device including
a communication module connectable to both a first cellular communication network and a second cellular communication network, and
a control unit, in which
when a failure occurs in the first cellular communication network, the control unit switches a communication network to be used to the second cellular communication network for a vehicle mounted application classified into a prescribed category from among a plurality of vehicle mounted applications that use the first cellular communication network.

Moreover, as other aspects, a method that is executed by the device, a program for causing a computer to execute the method, and a computer-readable storage medium that stores the program in a non-transitory manner, are provided as examples.

According to the present disclosure, securing of availability and suppression of cost in communication can both be established.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a vehicle communication network according to a first embodiment;

FIG. 2 is a schematic diagram showing a detailed configuration of a DCM10;

FIG. 3 is a schematic diagram showing the configuration of the server device 20 in detail;

FIG. 4 is a diagram for explaining a communication path for each vehicle mounted application;

FIG. 5 illustrates an exemplary configuration stored in a DCM10; and

FIG. 6 is a flow chart of a process executed by DCM10.

### DETAILED DESCRIPTION OF EMBODIMENTS

In recent years, the connectivity of automobiles has advanced, and the number of vehicles equipped with an in-vehicle device having a wireless communication function has increased. For example, the in-vehicle device can provide various services to an occupant of the vehicle by communicating with a server device (such as an application server) via a cellular communication network.

However, in such a system, if a failure occurs in the cellular communication network, the provision of the service may be interrupted.

On the other hand, the application software (hereinafter, vehicle mounted application) executed in the in-vehicle device includes an application that makes a notification when an emergency situation occurs, for example, an application that automatically makes a notification to an ambulance or a fire department when an accident occurs. It requires high availability.

In order to prepare for a communication failure, there is a method of contracting with a plurality of communication companies and securing a communication path for backup, but there is a problem that a cost is incurred (for example, a maintenance cost of two lines is incurred).

The information processing device of the present disclosure solves such a problem.

An information processing device according to a first aspect of the present disclosure includes:
a communication module connectable to both a first cellular communication network and a second cellular communication network, and
a control unit, in which
when a failure occurs in the first cellular communication network, the control unit switches a communication network to be used to the second cellular communication network for a vehicle mounted application classified into a prescribed category from among a plurality of vehicle mounted applications that use the first cellular communication network.

The first cellular communication network and the second cellular communication network may be, for example, communication networks provided by different communication companies.

The vehicle mounted application is application software executed by an in-vehicle device. The vehicle mounted application may be executed in the information processing device according to the present disclosure, or may be executed in another in-vehicle device. In addition, there may be a plurality of vehicle mounted applications that can be executed. The vehicle mounted application performs communication using the first cellular communication network as a default communication path.

When a failure occurs in the first cellular communication network, the control unit switches the communication network to be used to the second cellular communication network for the vehicle mounted application classified into the prescribed category among the plurality of vehicle mounted applications using the first cellular communication network.

That is, instead of switching the communication paths of all the vehicle mounted applications to the second cellular communication network, switching is performed by limiting the target vehicle mounted applications. The prescribed category may be a category in which availability is required (undesirably becoming unable to communicate), for example, a category related to safety. Note that the vehicle mounted applications classified other than the prescribed category are not switched from the first cellular communication network.

According to this configuration, it is possible to minimize the amount of data transmitted and received via the second cellular communication network. That is, it is possible to ensure the availability of communication and suppress an increase in the communication cost.

Note that the second cellular communication network may be a communication network in which the basic usage fee is lower than that of the first cellular communication network and the communication fee per unit data amount is higher than that of the first cellular communication network.

Further, the control unit may determine the category of the vehicle mounted application based on the communication message from the vehicle mounted application. For example, the communication message transmitted by the vehicle mounted application may include an identifier related to the category of the vehicle mounted application, and the control unit may identify the category of the target vehicle mounted application by using the identifier.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### First Embodiment

### Network Overview

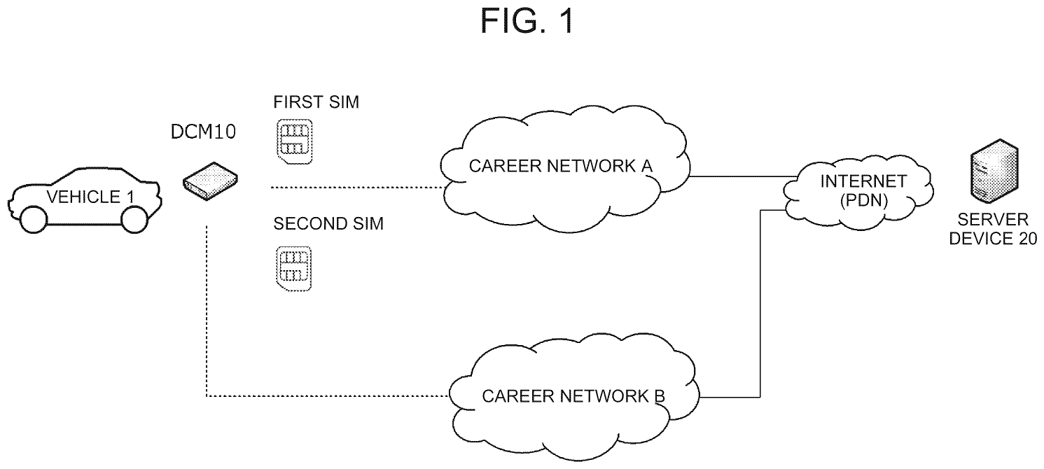

An outline of the vehicle communication network according to the first embodiment will be described with reference to FIG. 1. The vehicle communication network according to the present embodiment includes a DCM10 mounted on the vehicle 1 and a server device 20. The server device 20 is a device that provides a predetermined service to the vehicle 1. The vehicle 1 is configured to be capable of communicating with the outside via a cellular communication network (hereinafter, also referred to as a carrier network). The carrier network is connected to the Internet. The server device 20 is connected to the Internet, and the vehicle 1 (DCM10) can communicate with the server device 20 via the carrier network A or via the carrier network B. Note that a plurality of vehicles 1 and a plurality of server devices 20 may be included in the system.

The carrier network A is an example of the “first cellular communication network” of the present disclosure, and the carrier network B is an example of the “second cellular communication network” of the present disclosure.

The vehicle 1 is a connected vehicle capable of communicating with an arbitrary external device via a cellular communication network. In the present embodiment, the vehicle 1 can provide various services to the occupant of the vehicle by communicating with an external server device (for example, the server device 20) via a DCM10 that is a radio communication device. Examples of the various services include a navigation service, a remote control (e.g., remote air conditioning) service, an in-vehicle Wi-Fi (registered trademark) service, and an emergency notification service. In addition to the illustrated devices, the vehicle 1 may include an in-vehicle terminal that provides these services.

DCM10 is a device that wirelessly communicates with a predetermined network in order to connect a component (for example, an in-vehicle terminal) included in the vehicle 1 to the server device 20. In the present embodiment, DCM10 is configured to be connectable to a predetermined cellular communication network. DCM10 is configured with an eUICC (Embedded Universal Integrated Circuit Card) for identifying the user. eUICC may be a physical SIM card, an eSIM, or the like. In the present embodiment, DCM10 includes an eUICC for connecting to the carrier network A, i.e., a first SIM, and an eUICC for connecting to the carrier network B, i.e., a second SIM.

In the illustrated embodiment, DCM10 is configured to be able to communicate with the carrier network A. The carrier network A includes a base station of a cellular communication network, a control device that manages a mobile communication terminal, and the like.

In the present embodiment, the carrier network A is connected to the Internet via a packet gateway (PGW) or the like.

DCM10 is authenticated from the carrier network A using the profile data stored in the first SIM. In the present embodiment, the authentication device included in the carrier network A authenticates DCM10 based on the profile data included in the first SIM. The authenticated DCM10 can communicate with a PDN (e.g., the Internet) and initiate communication with the server-device 20.

As shown in the drawing, in a configuration in which DCM10 is connected to the cellular communication network (carrier network A), when a communication failure occurs in the carrier network A, the communication is interrupted.

On the other hand, in the vehicle 1, there is a case where a vehicle mounted application that detects occurrence of a traffic accident or the like and automatically makes a notification operates. If a communication failure occurs, these vehicle mounted applications will not operate, which is undesirable for safety reasons.

In order to cope with this, in the present embodiment, DCM10 is configured so as to be able to connect to an alternative cellular communication network (carrier network B) different from the default cellular communication network (carrier network A). Even when the carrier network A becomes unavailable, communication is continued on an alternative route.

Specifically, DCM10 has the second SIM that is an eUICC for connecting to the carrier network B, and can be used to connect to the carrier network B. DCM10 has a dual standby function and can simultaneously connect to the carrier network A and the carrier network B.

DCM10 uses the carrier network A as the main line. That is, in a normal state, DCM10 uses only the carrier network A as a communication line. On the other hand, when a failure occurs in the carrier network A, DCM10 limits the communication path to a path via the carrier network B.

DCM10 relays communication from a plurality of vehicle mounted applications, but switches communication paths when a failure occurs only for limited vehicle mounted applications. Specifically, the route is switched to the route via the carrier network B only for the vehicle mounted application in which the safety of the occupant may be impaired due to the interruption of the communication. In other words, the communication path is not switched for a vehicle mounted application that does not directly affect safety. Accordingly, it is possible to suppress the communication cost while ensuring safety.

The carrier network B may be a communication network in which the basic usage fee is lower than that of the carrier network A and the communication fee per unit communication amount is higher than that of the carrier network A. Such a communication network can be said to be suitable for backup applications.

### Device Configuration

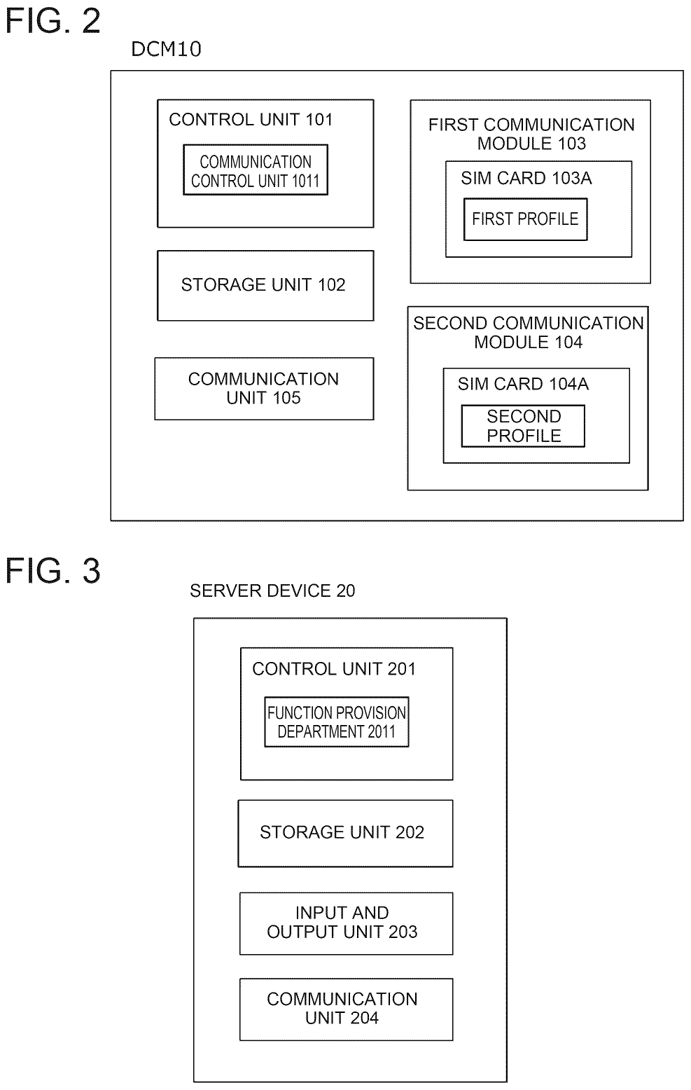

Next, the configuration of each device included in the system will be described. FIG. 2 is a diagram schematically illustrating an exemplary configuration of DCM10 according to the present embodiment.

DCM10 can be configured as a computer having a processor (such as a CPU, GPU), a main storage device (such as a RAM, ROM), and a secondary storage device (such as an EPROM, a hard disk drive, a removable medium, and the like). The secondary storage device stores an operating system (OS), various programs, various tables, and the like. By executing the program stored therein, it is possible to realize each function (software module) that meets a predetermined purpose, as will be described later. However, some or all of the functions may be realized as a hardware module by, for example, hardware circuitry such as an ASIC, FPGA.

DCM10 includes a control unit 101, a storage unit 102, a first communication module 103, a second communication module 104, and a communication unit 105.

The control unit 101 is an arithmetic unit that implements various functions of DCM10 by executing a predetermined program. The control unit 101 can be realized by, for example, a hardware processor such as a CPU. In addition, the control unit 101 may be configured to include a RAM, ROM (Read Only Memory), a cache memory, and the like.

In the present embodiment, the control unit 101 included in DCM10 includes a communication control unit 1011 as a software module. The software module may be realized by executing a program stored in the storage unit 102 by a control unit 101 (CPU) or the like. Note that the information processing executed by the software module is synonymous with the information processing executed by the control unit 101 (CPU) or the like.

The communication control unit 1011 establishes a network connection with a predetermined cellular communication network and relays communication in response to a request from a vehicle component of the vehicle 1.

The communication control unit 1011 has a function of simultaneously connecting to a plurality of carrier networks. For example, when the first SIM is inserted into DCM10, the communication control unit 1011 establishes a network connectivity via the carrier network A. When the second SIM is inserted into DCM10, the communication control unit 1011 establishes a network connectivity via the carrier network B. The networking may be maintained at all times during the energization of DCM10.

The communication control unit 1011 receives the authentication using the profile information (first profile) stored in the first SIM when the network is connected via the carrier network A. In addition, the communication control unit 1011 receives the authentication using the profile information (second profile) stored in the second SIM when the network is connected via the carrier network B.

The communication control unit 1011 has a dual standby function, maintains the connection of both the carrier networks A and B, and can distribute the communication generated in the vehicle 1 to any network.

The storage unit 102 is means that stores information, and is composed of a storage medium such as a RAM, a magnetic disk, or a flash memory. The storage unit 102 stores programs executed by the control unit 101, data used by the programs, and the like.

The first communication module 103 is a communication device that performs wireless communication with a predetermined network. In the present embodiment, the first communication module 103 is configured to be capable of communicating with a predetermined cellular communication network (carrier network A).

The first communication module 103 includes a SIM card 103A. SIM card 103A is the first SIM in FIG. 1. SIM card 103A is configured as a microcomputer including a CPU and a storage device. SIM card 103A has information (PLMN information) for connecting to the carrier network A.

Further, SIM card 103A (first SIM) is configured to store a first profile that is SIM profile data. The first profile is a profile issued by a carrier operator managing the carrier network A. The first profile includes identification information such as IMSI (International Mobile Subscription Identity) and ICCID (Integrated Circuit Card ID), and authentication information (key information) for receiving SIM authentication including AKA authentication.

The second communication module 104 is a communication device that performs wireless communication with a predetermined network. In the present embodiment, the second communication module 104 is configured to be capable of communicating with a predetermined cellular communication network (carrier network B).

The second communication module 104 includes a SIM card 104A. SIM card 104A is the second SIM in FIG. 1. SIM card 104A is configured as a microcomputer including a CPU and a storage device. SIM card 104A has information (PLMN information) for connecting to the carrier network B.

Further, SIM card 104A (the second SIM) is configured to store a second profile that is SIM profile data. The second profile is a profile issued by a communication carrier managing the carrier network B. The second profile includes identification information such as IMSI (International Mobile Subscription Identity) and ICCID (Integrated Circuit Card ID), and authentication information (key information) for receiving SIM authentication including AKA authentication.

The communication unit 105 is a communication interface for connecting the DCM10 to the in-vehicle network of the vehicle 1. The communication unit 105 may be configured to include a network interface that performs communication according to, for example, CAN (Controller Area Network). DCM10 can perform data communication with other components (for example, an in-vehicle terminal or the like) of the vehicle 1 via the communication unit 105.

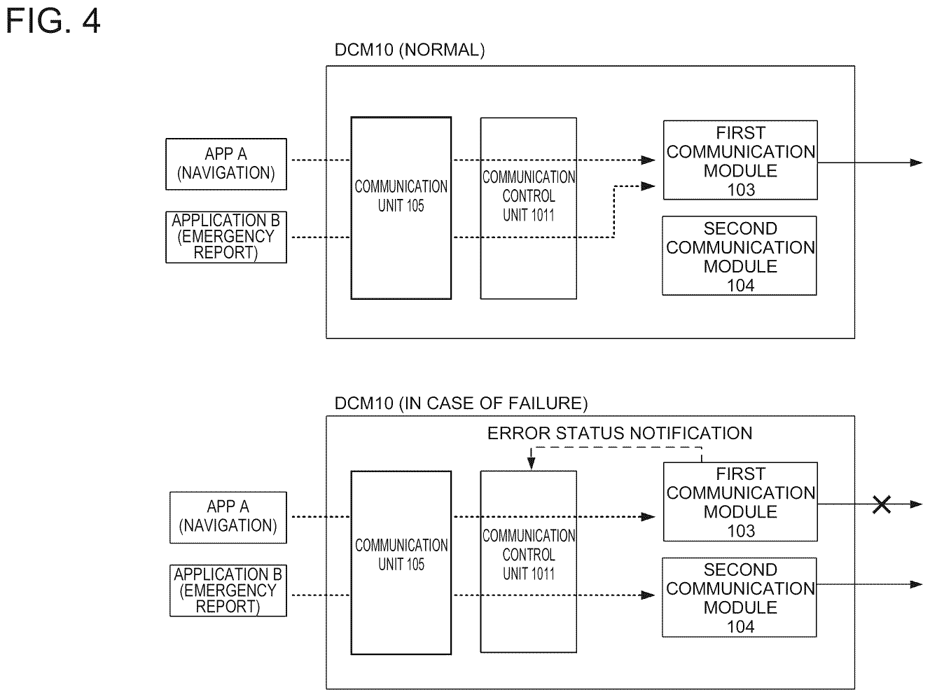

Next, the configuration of the server device 20 will be described. FIG. 4 is a diagram schematically illustrating an example of a configuration of the server device 20 according to the present embodiment.

The server device 20 is configured as a computer including a control unit 201, a storage unit 202, an input/output unit 203, and a communication unit 204.

The server device 20 can be configured as a computer including a processor (such as a CPU, GPU), a main storage device (such as a RAM, ROM), and a secondary storage device (such as an EPROM, a hard disk drive, and a removable medium). However, some or all of the functions (software modules) may be realized as hardware modules by hardware circuitry such as an ASIC, FPGA, for example.

The control unit 201 is an arithmetic unit that realizes various functions (software modules) of the server device 20 by executing a predetermined program. The control unit 201 can be realized by, for example, a hardware processor such as a CPU.

In the present embodiment, the control unit 201 included in the server device 20 includes a function providing unit 2011 as a software module. The software module may be realized by executing a program stored in the storage unit 202 by a control unit 201 (CPU or the like). Note that the information processing executed by the software module is synonymous with the information processing executed by the control unit 201 (CPU or the like).

The function providing unit 2011 provides various functions or services in response to a request transmitted from the vehicle 1. Examples of the functions or services provided by the function providing unit 2011 include the following.
(1) Providing information services
For example, a service that provides traffic information, regional information, and other information.
(2) Route navigation service
A service that performs route navigation based on an online map.
(3) Streaming service
This is a service for streaming music or video.
(4) Remote control service
This service controls the car air conditioner from outside the car and monitors the surroundings of the car.
(5) Mayday system
This service detects the occurrence of a traffic accident and automatically reports it to the operators of related organizations (fire department and emergency).

Note that the functions or services provided by the function providing unit 2011 may be other than those exemplified here.

The storage unit 202 is means that stores information, and is composed of a storage medium such as a RAM, a magnetic disk, or a flash memory. The storage unit 202 stores programs executed by the control unit 201, data used by the programs, and the like.

The input/output unit 203 is a unit that receives an input operation performed by an operator of the device and presents information to the operator. In the present embodiment, a single touch panel display is used. That is, the apparatus includes a liquid crystal display, a control unit thereof, a touch panel, and a control unit thereof.

The communication unit 204 is a communication interface for connecting the server device 20 to the Internet. The server device 20 can perform data communication with the Internet via the communication unit 204.

### Distribution Processing of Communication

Next, a communication distribution process performed by DCM10 (communication control unit 1011) will be described. FIG. 4 is a diagram for explaining a communication sorting process. In this example, two examples of the vehicle mounted application include an application that provides a navigation function (application A) and an application that provides an emergency notification function (application B). The application A is a vehicle mounted application belonging to the category of “navigation”, and the application B is a vehicle mounted application belonging to the category of “emergency notification”.

The communication unit 105 included in DCM10 acquires the communication message from the vehicle mounted application operating in the in-vehicle device via the in-vehicle network. The communication message may be, for example, a request statement in a particular protocol (e.g., a HTTP). The communication message may be transmitted together with an identifier of the vehicle mounted application or an identifier indicating a category of the vehicle mounted application. These identifiers may be included in the communication message itself.

The communication message acquired by DCM10 is inputted to the communication control unit 1011.

The communication control unit 1011 transfers the received communication message to the communication module. In the present embodiment, since DCM10 uses the carrier network A as the main line, the communication control unit 1011 forwards the communication message to the first communication module 103 at a normal time. The first communication module 103 configures a packet based on the received communication message and transmits the packet to the carrier network A. As a result, the communication from each vehicle mounted application reaches the server device 20 via the carrier network A. When a response is received from the server device 20, the communication control unit 1011 forwards the response to DCM10.

Next, a case where a failure occurs in the carrier network A will be considered.

When a failure occurs in the carrier network A, communication via the first communication module 103 cannot be performed normally. For example, a communication time-out or an abnormal status code is returned. When such an abnormality is detected, the first communication module 103 provides information (abnormality status notification) to the communication control unit 1011. Thus, the communication control unit 1011 can recognize that a failure has occurred in the carrier network A.

Note that the information provided from the first communication module 103 to the communication control unit 1011 is not necessarily related to an abnormality. For example, the information may be information related to a status occurring in normal wireless communication. The communication control unit 1011 may determine occurrence of a failure based on the information.

When recognizing that a failure has occurred in the carrier network A, the communication control unit 1011 switches the relay destination of communication from the vehicle mounted application to a different carrier network. In the present embodiment, the communication control unit 1011 switches the network used by the vehicle mounted application from the carrier network A to the carrier network B on condition that the target vehicle mounted application belongs to a specific category.

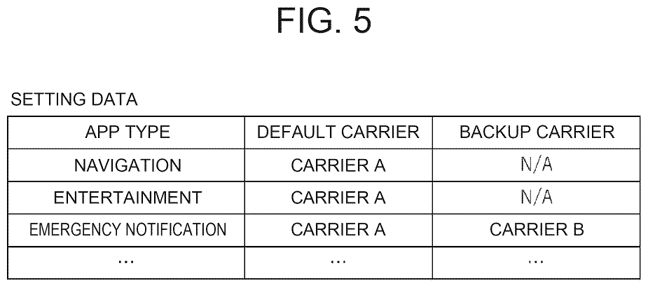

FIG. 5 is an example of data (setting data) for defining a target category. The setting data is data defining which category the vehicle mounted application belonging to is to be switched. The setting data may be stored in the storage unit 102. In the example of FIG. 5, three categories of “navigation”, “entertainment”, and “emergency notification” are defined as categories of the vehicle mounted application. These vehicle mounted applications use the carrier network A as a default line. In addition, among the three categories, for the vehicle mounted application having the category of “emergency notification”, it is defined that the carrier network B is available as a backup carrier.

When a failure occurs in the carrier network A, the communication control unit 1011 switches the network used by the vehicle mounted application belonging to the category of “emergency report” from the carrier network A to the carrier network B. The category of the vehicle mounted application requesting communication can be determined based on information included in the communication message or information associated with the communication message. When the determined category is other than “emergency report”, the communication control unit 1011 does not switch the network to be used. That is, the communication from the application A is relayed to the first communication module 103, and only the communication from the application B is relayed to the second communication module 104. As a result, the normal operation of the application B can be continued. Since the application A continues to use the carrier network A, normal operation cannot be performed until the communication failure is restored. Flowchart

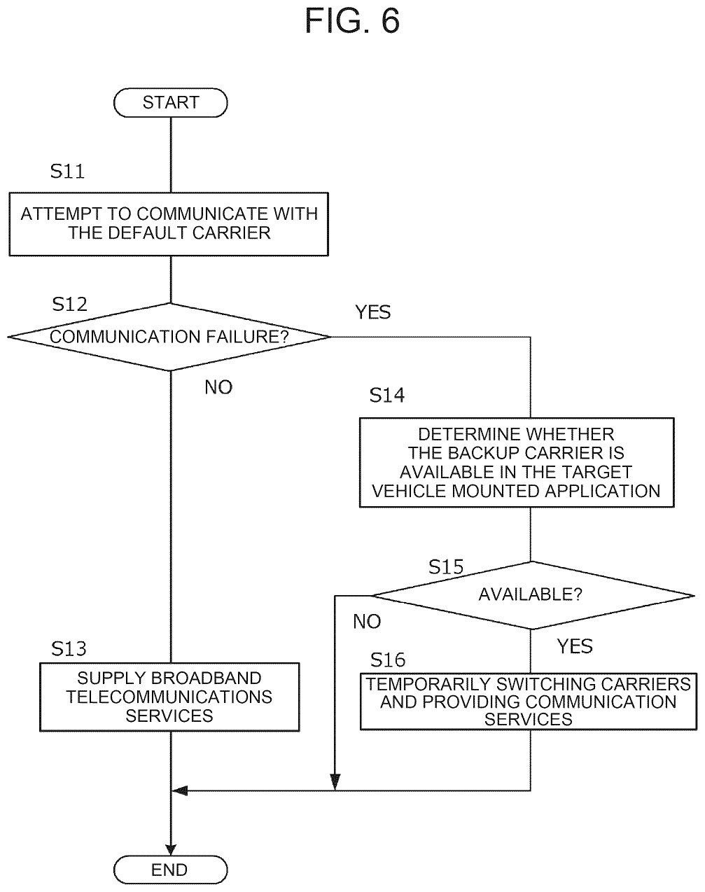

Next, the process executed by DCM10 will be described in detail. FIG. 6 is a flow chart of a process executed when DCM10 (communication control unit 1011) receives a communication request from the vehicle mounted application.

First, in S11, the communication control unit 1011 attempts communication using the default carrier. In the present embodiment, the default carrier is carrier network A. The status obtained as a result of the trial is notified from the first communication module 103 to the communication control unit 1011. For example, when attachment to the carrier network fails, establishment of a communication path to the Internet fails, or when a communication timeout occurs, an abnormality status notification is transmitted from the first communication module 103 to the communication control unit 1011.

In S12, the communication control unit 1011 determines whether or not a communication failure has occurred in the carrier network A. For example, when the above-described abnormality status notification is transmitted from the first communication module 103, it can be determined that a failure has occurred in the communication. The communication control unit 1011 may comprehensively determine the occurrence of a failure based on the frequency of reception of the abnormality status notification and the number of times of reception. For example, in a case where a plurality of communication abnormalities is recognized in a predetermined period, it may be determined that a failure has occurred in the carrier network A.

When a communication failure is not recognized in S12, the process transitions to S13, and the communication control unit 1011 provides a communication service to the target vehicle mounted application. In this case, communication using the carrier network A is performed.

In S12, if a communication failure is found, the process transitions to S14. In S14, the communication control unit 1011 determines whether or not the target vehicle mounted application belongs to a category in which the backup carrier can be used. For example, the communication control unit 1011 determines the category of the vehicle mounted application based on the communication message received from the target vehicle mounted application. Further, the communication control unit 1011 may acquire the setting data as described with reference to FIG. 5 and check the category to determine whether or not the target vehicle mounted application belongs to a category in which the use of the backup carrier is permitted.

Here, if it is determined that the backup carrier is available (S15-Yes), the process transitions to S16. If it is determined that the backup carrier is unavailable (S15-No), the process ends.

In S16, the communication control unit 1011 temporarily switches the communication path from the target vehicle mounted application to the path using the backup carrier. In the present embodiment, communication from the vehicle mounted application is relayed to the second communication module 104. As a result, communication using the carrier network B is started.

The provision of information from the first communication module 103 to the communication control unit 1011 may be continued. For example, the first communication module 103 may periodically transmit information on the status of the carrier network A to the communication control unit 1011. According to this configuration, the communication control unit 1011 can recognize in real time that the communication failure occurring in the carrier network A has been restored.

In this case, the communication control unit 1011 may switch from the backup carrier to the default carrier again. That is, the network used by the application B may be switched from the carrier network B to the carrier network A.

The switching from the backup carrier to the default carrier may be attempted at an arbitrary timing. For example, when the traveling system of the vehicle 1 is shut down, the use of the backup carrier may be terminated. In this case, the use of the carrier network A is resumed at a timing at which the traveling system of the vehicle 1 is activated next. If the communication failure of the carrier network A continues, switching is performed again according to the flow of FIG. 6.

As described above, DCM10 according to the first embodiment is configured to be connectable to a plurality of carrier networks, and can continue communication even when one of the carrier networks is down. Further, DCM10 acquires information for categorizing the vehicle mounted application, and sets only the vehicle mounted application belonging to the prescribed category as the target of the network switching. Thus, even when the default carrier network is down, it is possible to continue communication from the vehicle mounted application that plays an important role. Furthermore, the network is not switched for a vehicle mounted application belonging to a category other than the prescribed category. This makes it possible to reduce the communication cost.

Note that, in the present embodiment, the category “emergency report” is exemplified as a prescribed category, but other categories may be targeted as long as they relate to safety. As such, for example, a vehicle mounted application for safely driving a vehicle, a vehicle mounted application for protecting an occupant from danger, and the like can be exemplified.

### Modified Examples

The above-described embodiments are merely examples, and the present disclosure may be appropriately modified and implemented without departing from the scope thereof.

For example, the processes and means described in the present disclosure can be freely combined and implemented as long as no technical contradiction occurs.

Note that the communication control unit 1011 may guide the occupant of the own vehicle to that effect during a period in which it is recognized that a communication failure has occurred in the carrier network A. In addition, in a case where the recovery of the carrier network A is recognized, similarly, this fact may be guided to the occupant of the own vehicle.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. Non-transitory computer-readable storage media include any types of disks, such as magnetic disks (floppy disks, hard disk drives (HDD), etc.), optical disks (CD-ROM, DVD disk Blu-ray disks, etc.). Non-transitory computer-readable storage media include read only memory (ROM), random access memory (RAM), EPROM, EEPROM, magnetic cards, flash memory, optical cards, any type of media suitable for storing electronic instructions.

What is claimed is:

1. An information processing device comprising:
a communication module connectable to both a first cellular communication network and a second cellular communication network; and
a control unit, wherein
when a failure occurs in the first cellular communication network, the control unit switches a communication network to be used to the second cellular communication network for a vehicle mounted application classified into a prescribed category from among a plurality of vehicle mounted applications that use the first cellular communication network.

2. The information processing device according to claim 1, wherein the control unit continues use of the first cellular communication network for a vehicle mounted application that is not classified into the prescribed category.

3. The information processing device according to claim 2, wherein the prescribed category is a category related to safety.

4. The information processing device according to claim 1, wherein the control unit determines a category of the vehicle mounted application based on a communication message from the vehicle mounted application.

5. The information processing device according to claim 1, wherein the second cellular communication network is a communication network in which a basic usage fee is lower than a basic usage fee of the first cellular communication network and a communication fee per unit communication amount is higher than a communication fee per unit communication amount of the first cellular communication network.
